(19) United States
(12) Patent Application Publication
(10) Pub. No.: US 2007/0061174 A1
(43) Pub. Date: Mar. 15, 2007

(54) System, method, and computer program product for detecting and resolving pricing errors for products listed in an inventory system

(75) Inventor: Bernard Phillips, Flower Mound, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Travelocity.com LP

(21) Appl. No.: 11/224,164

(22) Filed: Sep. 12, 2005

(51) Int. Cl. G06Q 10/00

(52) U.S. Cl. 705/5

(57) ABSTRACT

The present invention generates a concise display of travel products, received from an inventory system, that are associated with potentially erroneous fare prices. Specifically, embodiments of the present invention compare travel product sales parameters such as, for example, price and sales volume, to averages of comparable sales parameters from stored and/or real-time data in order to identify and/or display travel products having pricing and/or sales volume that differs substantially from comparable average sales parameters. Thus, the present invention may alert an operator of the system of potentially erroneous fare prices that may be displayed to a customer in response to a search for travel products.

### BACKGROUND OF THE INVENTION

1. Field of the Invention

The present invention relates to the field of mechanized inventory systems, such as airline reservations systems or other product and/or service reservation or inventory systems, which are used to determine availability and pricing for products and/or services. More particularly, the embodiments of the present invention are adapted to detect and/or display pricing errors that may occur in an inventory system by comparing purchase prices to average purchase prices and detecting purchase prices and or purchase volumes that deviate from the average purchase prices and/or volumes for a selected subset or category of products.

2. Description of Related Art

Many of today's products and services are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline seat availability, hotel reservations, car rentals, event availability, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, and AXESS.

Consumer interaction with these systems has evolved in recent years. Initially, these systems were difficult to use and did not always provide the best solution to a consumer's query. For example, in the early stages, a consumer interested in booking airline tickets would input a desired flight itinerary with desired travel dates and times and possible selected class of travel. The CRS system would check availability for the dates and return with a fare price meeting the specific input dates and times requested. Although there were some algorithms in place to aid the consumer in finding the lowest-priced fare, these algorithms were typically geared more toward providing quick results with less computing time and resources than in finding the lowest priced fare. For example, some early product availability and booking algorithms used a method that would heuristically select a subset of itineraries from a larger pool of itineraries, price this subset, and select the lowest-priced fare from the subset for display to the consumer. While these early systems provided timely results and reduced processing load on the CRS, they did not always provide the best solution to the consumer.

In light of this, the assignees of the present invention, developed an algorithm, (sometimes referred to as extended implicit enumeration algorithm), that could be used to efficiently determine the lowest fare for a particular flight itinerary. The algorithm used a k-shortest path schema that identified the lowest available fare that met a consumer's request and displayed this fare to the consumer. This algorithm is described more fully in U.S. patent application Ser. No. 09/421,895, filed on Oct. 21, 1999, entitled Method and Apparatus for Searching for a Low Fare for Travel between Two Locations, and published as a PCT application under Publication No. WO 01/29693; the contents of which are incorporated herein.

The extended implicit enumeration algorithm was a major step forward in efficiently determining the lowest fare price for a given itinerary; it does have a few slight drawbacks. Specifically, the algorithm was designed to provide a small number of low priced answers with minimal consideration of diversity. The consumer inputs a request, and the algorithm returns only the lowest fare meeting the request. Unfortunately, such a process may not provide the best solution to a consumer or may miss an opportunity to market different fares to a customer that may maximize profits for the supplier, while also meeting the consumer's goals. Thus the assignee of the present invention developed a system, method, and computer program product to provide a plurality of low fare prices and different flight itinerary options for a given departure and return date combination, thereby allowing a user to view these different options and make a determination as to which fare and flight itinerary meets their goals as described more fully in U.S. Provisional Patent Application Ser. No. 60/573,546, filed on May 21, 2004, entitled Systems, Methods, and Computer Program Products for Searching and Displaying Low Cost Product Availability Information for a Given Departure-Return Date Combination or Range of Departure-Return Date Combinations; the contents of which are also incorporated herein.

While conventional searching systems for travel products may provide a user with a multitude of different low-cost options in the form of a results listing, such conventional systems rely on accurate pricing information, such that the consumer receives a product at a promised price that allows both the search system operator and the travel product provider to realize a profit in providing the search service and the final travel product. Pricing for travel products is often highly variable and depends on a number of factors including, for example, geographical area of travel, the travel product supplier, the travel product class, and/or other factors. Furthermore, errors in pricing of such travel products may be introduced at a number of points prior to the display of product options to a user. For example, pricing errors may be introduced by one or more of: the travel product provider (in supplying pricing information to a CRS), the CRS operator (in translating and/or listing pricing information taken from a travel product provider), and/or the search system operator (by misinterpreting and/or misreading pricing information from a CRS and/or travel product provider). In conventional search systems, however, pricing errors often go undetected until large numbers of customers have booked unusually low (and erroneously-assigned) fares for a travel product through a CRS or a search system in communication therewith.

Conventional systems lack the capability to track and highlight potentially inaccurate travel product pricing (or other travel product parameters) that may be displayed erroneously to a search system user via the search system. In such cases, at least one party involved in the transaction, such as, for example, the search system user, the search system operator, and/or the travel product provider must bear the losses associated with such a mistake. For example, if an erroneously low airline fare is offered to the consumer via the search system, the travel product provider (such as an airline) must, in some cases, honor the listed price and provide the travel product at a loss. In other instances, the search system operator must bear the losses associated with such a mistake. In any case, the costs of travel product pricing errors exceed mere lost profits and may lead to a deterioration in relationships between the search system operator and its customers (the search system users, for example) and its suppliers (travel product suppliers, such as airlines, for example).

The limitations in conventional search systems may create a burden on an inventory system operator that seeks to identify and remove pricing errors before they are either presented to a customer and/or relied upon by multiple customers in the sale of travel products, such as airline tickets. Specifically, since conventional search systems are not capable of computing an average price (or other travel product parameter, such as sales volume) and systematically comparing the average price to prices for travel products presented to a customer, the search system operator is forced to constantly monitor new pricing schemes (which may be updated by the minute and may include thousands of travel products and fare categories) in order to attempt to identify potential pricing errors.

Therefore, there exists a need for an improved system to solve the technical problems outlined above that are associated with conventional search systems. More particularly, there exists a need for a system capable of automatically identifying and displaying travel products having prices (or other sales parameters such as, for example, sales volumes) that differ greatly from an average price for comparable travel products. There also exists a need for a system that periodically searches an inventory system for possibly erroneous travel product price listings such that an operator of the inventory system and/or search system may be aware of such potentially erroneous price listings before they result in lost profits and/or customer dissatisfaction. Furthermore, there exists a need for a search system that displays travel products having potentially erroneous price listings (as identified, for example, by comparing a product parameter to an average product parameter in a comparable product category) directly to travel product providers so as to efficiently notify such product providers when a potentially erroneous price listing for a product has been listed in an inventory system.

### BRIEF SUMMARY OF THE INVENTION

The needs outlined above are met by the present invention which, in various embodiments, provides a system that overcomes many of the technical problems discussed above, as well other technical problems, with regard to the early detection, accurate identification, and display of potential pricing errors by conventional travel product search systems. Specifically, in one embodiment, the system of the present invention detects and displays pricing errors corresponding to one or more travel products selected from an inventory system. In one embodiment, the system comprises a database comprising a plurality of first travel products in at least one category, wherein the first travel products have a corresponding plurality of first parameters. The system further comprises a host computing element in communication with the database and the inventory system. The host computing element may, in some embodiments, receive, from the inventory system, a second travel product, in the at least one category, having a corresponding second parameter. The host computing element may also determine an average of the first parameters associated with each of the plurality of first travel products in the at least one category and compare the second parameter and the average. According to some embodiments, the host computing element also displays the second travel product when the second parameter associated therewith is different from the average so as to identify potential pricing errors corresponding to the displayed second travel product. Thus, systems of the present invention may identify potential pricing errors by systematically comparing travel product pricing to stored pricing patterns for comparable travel products within the same categories.

Furthermore, in some system embodiments, the system further comprises a memory device for storing the determined average. The system of the present invention may also further comprise a user interface in communication with the host computing element for displaying the second travel product when the second parameter (associated with the second travel product) is different from the average. According to some system embodiments, the host computing element may further display the second travel product when the second parameter associated therewith is different from the average by a selected margin. In some additional system embodiments, the host computing element may also: transmit the displayed second travel product to a product provider in communication with the host computing element; and/or verify the determined relation between the second parameter and the average. Furthermore, in some system embodiments, the host computing element may also automatically remove the displayed second travel product from the inventory system so as to prevent the sale of potential incorrectly travel products via the inventory system.

The parameters received and/or stored by the system embodiments of the present invention may comprise, for example, fare price, fare sales volume; and combinations thereof, as both unusual fare prices and unusually low and/or high sales volume may be indicative of a pricing error for a particular travel product. Furthermore, the category of the travel products evaluated by system embodiments of the present invention may comprise, for example, at least one of: a travel product geographical market area; a travel product supplier; a travel product itinerary; an airline fare having a selected fare code; an airline fare for travel on a selected itinerary; and combinations thereof. The parameters and categories established by the system embodiments of the present invention may be used by the host computer element to more effectively compare the second parameter associated with the second travel product to a suitable average so as to more accurately identify potential pricing errors in the second travel product.

Further, the present invention also provides methods and/or computer program products for detecting and displaying pricing errors corresponding to one or more travel products selected from an inventory system, wherein the inventory system comprises travel products and parameters associated with the travel products. According to one embodiment, the method and/or computer program product comprises: determining an average of a parameter associated with each of a plurality of first travel products in at least one category; comparing a second travel product in the at least one category, the second travel product being associated with the parameter, to the plurality of plurality of first travel products so as to determine a relation between the parameter associated with the second travel product and the average; and displaying the second travel product when the parameter associated with the second travel product is different from the average so as to identify possible pricing errors corresponding to the displayed second travel product.

According to some embodiments, the method and/or computer program product may further comprise a step for storing the average of the parameter in a memory device in communication with the inventory system. Furthermore, the displaying step described above may in some method and/or computer program product embodiments further comprise a step for displaying the second travel product when the parameter associated with the travel product is different from the average by a selected margin. Other method and/or computer program product embodiments further comprise transmitting the displayed travel product to a travel product provider in communication with the host computing element and/or verifying the determined relation between the parameter associated with the second travel product and the average. Additional embodiments of the method and/or computer program product of the present invention also comprise a step for automatically removing the displayed second travel product from the inventory system.

As described above with respect to the system embodiments, the travel product parameters monitored, averaged, and/or compared by the methods and computer program products may include, but are not limited to, price, sales volume, and combinations thereof. As discussed above, aberrant pricing levels and unusually high and/or low sales volume (within a given product category) may be indicative of a pricing error. Furthermore, the methods and computer program products of the present invention may compare parameter averages and second travel product parameters across a broad range of travel product categories, which may be defined by at least one of: a travel product geographical market area; a travel product supplier; a travel product itinerary; an airline fare having a selected fare code; an airline fare for travel on a selected itinerary; and combinations thereof.

Thus the systems, methods, and computer program products for detecting, displaying, and/or transmitting pricing errors corresponding to one or more travel products selected from an inventory system, as described in the embodiments of the present invention, provide many advantages that may include, but are not limited to: systematically comparing historical pricing and other product parameter data to newly received travel products to more effectively identify potential pricing errors in the received travel products; providing an easy-to-decipher display depicting detected potential incorrectly-priced travel products along with the comparative data used to identify the potential price error; providing a direct interface and notification system for partner organizations (such as travel product providers) such that the partners may easily view the detected potential pricing errors and take immediate action thereon to avoid potential profit losses; allowing a user of the system embodiments to select criteria used to detect potential price errors; and allowing a user to visually audit and/or verify the accuracy of price error determinations made by the system, method, and/or computer program product.

These advantages and others that will be evident to those skilled in the art are provided in the system, method, and computer program product of the present invention. Importantly, all of these advantages allow the system to accurately display travel products that, when compared to comparable pricing information, may be priced incorrectly. Since the displayed information is made more readily evident to the user and to the travel product providers, the user and/or travel product providers are more likely to identify and remove incorrectly-priced travel products before suffering significant losses in profit from pricing errors.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIGS. 1A and 1B illustrate a typical network environment in which the systems, methods, and computer program products may be implemented according to one embodiment of the present invention.

FIG. 2 is an illustration of the operation flow of the systems, methods, and computer program products in response to a user query including retrieval, comparing, and display steps, according to one embodiment of the present invention.

FIG. 3 is a graphical depiction of a display of second travel products and associated second parameters generated according to one embodiment of the systems, methods, and computer program products of the present invention illustrating a listing of second travel products that differ from a determined average by more than a specified margin.

FIG. 4 is an illustration of the operation flow of the systems, methods, and computer program products in response to a user query including retrieval, storing, comparing, and display steps, according to one embodiment of the present invention.

FIG. 5 is an illustration of the operation flow of the systems, methods, and computer program products in response to a user query including retrieval, comparing, display, and transmitting steps, according to one embodiment of the present invention.

FIG. 6 is an illustration of the operation flow of the systems, methods, and computer program products in response to a user query including retrieval, comparing, verifying, and display steps, according to one embodiment of the present invention.

FIG. 7 is an illustration of the operation flow of the systems, methods, and computer program products in response to a user query including retrieval, comparing, display, and removal steps, according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The systems, methods, and computer program products of the present invention are described in an airline ticket reservation environment. It must be understood that this is only one example of the use of the present invention. Specifically, the systems, methods, and computer program products of the present invention can be adapted to any number of products and services and are not limited to the airline industry. For example, the present invention may be used with rail and bus itineraries, hotels, cruises, restaurants, car rentals, events including sports and leisure activities, etc. In addition, embodiments of the present invention may also be used in a variety of non-travel industries for automatically identifying potential incorrectly-priced products. For example, the embodiments of the present invention may be useful, in some embodiments, for computing average market price for a commodity and comparing such an average price to one or more proposed pricing schemes to identify potential erroneous and/or incorrect pricing schemes. The embodiments of the present invention may be capable of detecting pricing errors in any number of complex pricing environments wherein there exists a number of pricing information sources that may be indicative of an average price with which a selected and/or proposed price may be compared to check for accuracy.

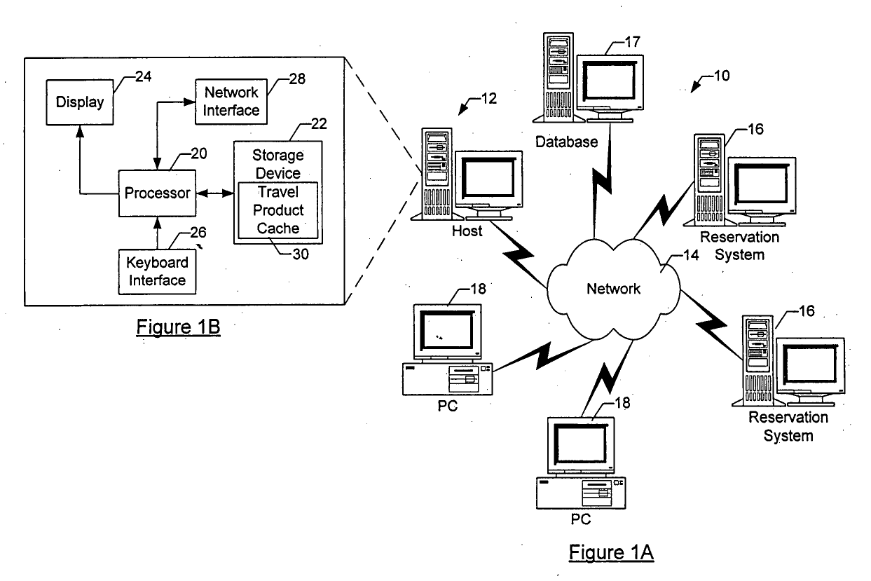

FIGS. 1A and 1B illustrate an example of a typical conventional network environment 10 in which the systems, methods, and computer program products of the present invention may be employed. The network includes a host computer 12 (or host computing element) connected to a wired and/or wireless network 14, such as a LAN, WAN, Intranet, computer network, or the Internet, for example, for detecting and displaying pricing errors corresponding to one or more travel products (such as airline ticket fares, for example) selected from an inventory system (such as a reservation system 16). Also connected to the network 14 are various reservation systems 16 containing a variety of travel products and parameters associated therewith. Such parameters may include, for example, pricing information, number of products sold at a given price, availability information, and other information for various travel product suppliers, such as hoteliers, airlines, car rental companies, etc. Further, users (such as, for example, online customers searching for airline fare prices) are also connected to the network via personal computers 18 or other types of computing systems.

The host computer 12 of the present invention may be in communication with one or more reservation systems 16 so as to monitor such reservation systems for potentially pricing errors for the travel products listed therein. In some embodiments, the host computer 12 may monitor the pricing of travel products on a third party reservation system 16 capable of listing travel products provided by a central computer reservation system (CRS, such as, for example SABRE) and/or a product provider reservation system (such as an airline reservation system and/or hotel reservation system, for example). As described in further detail below (and as shown generally in FIG. 1A), the host computer 12 of the present invention may be in communication with one or more of these different types of reservation systems 16 in order to, for example: (1) collect pricing data (and/or other parameters associated with travel products) from one or more of the reservation systems 16, (2) monitor one or more of such reservation systems 16 for potential incorrectly-priced travel products, and/or (3) transmit the detection of potentially mispriced travel products to one or more of the reservation systems 16.

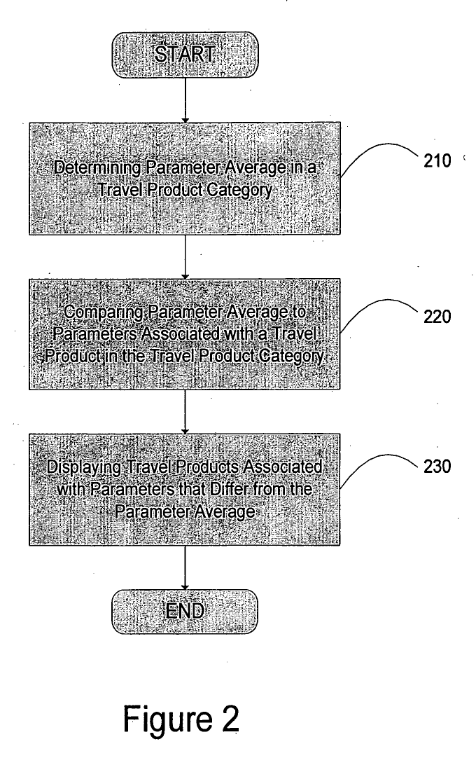

One or more databases 17 may also be connected to the network 14 such that the host computer 12 may be capable of interrogating the database 17 so as to be capable of accessing stored data including a plurality of first travel products (in at least one category) having a corresponding plurality of parameters. The categories and corresponding parameters of the plurality of first travel products stored in the database 17 may comprise, for example, fare prices for a specific air travel itinerary, fare prices on a particular airline, fare prices to and/or from a specific geographical region, fare prices for a particular airline fare code, and other category/parameter combinations that may be used to more effectively compare the average parameter of the plurality of first travel products (computed as described below) to the parameter of a given second travel product (as described in further detail below with respect to FIG. 2). In some embodiments of the present invention, wherein the system is used to detect pricing errors in airline fares, detailed category determinations (including time of travel, itinerary, season, fare class, etc.) may be stored by the database 17 and used by the host computer 12 to more accurately parse actual pricing errors from aggressive pricing schemes in competitive markets (such as heavy business travel routes between large cities). Furthermore, in some embodiments, the plurality of first travel products (in at least one category) having a corresponding plurality of parameters may also be stored in a memory device 22 (see FIG. 1B, for example) having a travel product cache 30 that may be integrated with and/or in communication with the host computer 12.

As shown in FIG. 1A, the database 17 may be in communication (via, for example, a wired and/or wireless network 14) with one or more reservation systems 17, as well as the host computer 12 for storing historical and/or real time data related to the plurality of first travel products having a corresponding plurality of parameters (such as pricing data) that may be received from the reservation systems and/or the host computer 12 via the network 14. The reception of data related to the plurality of first travel products having a corresponding plurality of parameters may be accomplished using “push” and/or “pull” arrangements that will be appreciated by one skilled in the art. For example, reservation systems 16, such as, for example, airline website booking sites, ticketing services may periodically “push” data to the database 17 in order to populate the database 17 with historical and/or near-real-time data related to the plurality of first travel products having a corresponding plurality of parameters. In other embodiments, the database 17 may “pull” data from network 14 nodes such as, for example, reservation systems 16, the host computer 12 (or a memory device 22 and/or travel product memory cache 30 included therein), or another computer system in communication with the database 17 via the network 14. Furthermore, in some system embodiments of the present invention, the database 17 may collect and store travel product data including multi-variable categories related to airline tickets such as, for example, ticket class (coach, business, first-class, non-refundable, economy, for example), the geographic area of the itinerary, airline, and/or fare code. Thus, the first plurality of travel products (having a corresponding plurality of first parameters) may be used to generate an average parameter (such as average ticket price, and/or average number of tickets sold) that may be accurately compared with the second travel product received from the reservation system 16 (see below).

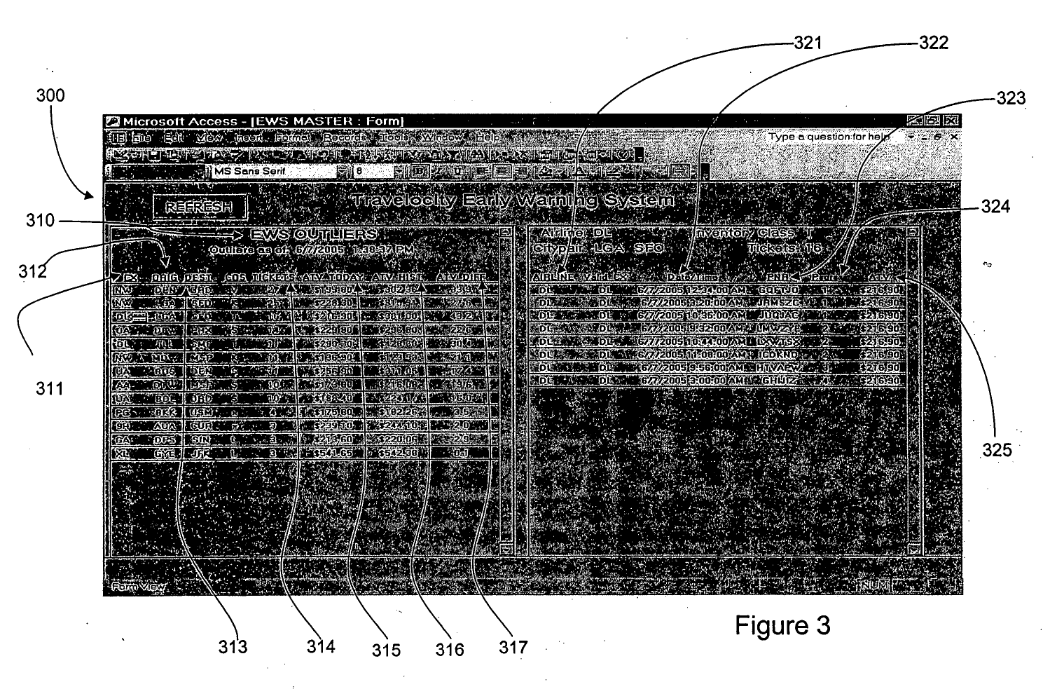

In operation, the system of the present invention, via the host computer 12, receives, from the reservation system 16 (via the network 14, for example) a second travel product (associated with a particular category and having a corresponding parameter). For example, the host computer 12 may receive from the reservation system 16 one or more airline ticket price listings for a particular air travel itinerary (such as a Saturday night, first-class, non-stop flight from New York to San Francisco), wherein the second travel product is the airline ticket, wherein the parameter is the price listing, and wherein the category comprises airline tickets for the particular first-class air travel itinerary (Saturday night, non-stop flight from New York to San Francisco). In some embodiments, the reception of such a second travel product by the host computer 12 may be triggered by the purchase of the second travel product by a consumer. For example, as shown in the display 300 of travel product “outliers” in FIG. 3, one embodiment of the present invention lists potentially-mispriced air fares that have been purchased from an inventory system during a particular time frame (as indicated by the listed purchase time and number of tickets purchased in the detailed display 320). In such embodiments, the host computer may be in communication with a ticketing and/or purchasing module of the reservation system 16 to receive purchasing information including a listing of the purchase price, time of purchase, travel product provider (airline, for example), and the number of travel products (tickets) purchased (both in the transaction at hand, and cumulatively over the course of a selected time period). According to various system embodiments, the host computer 12 may obtain the second travel product (and associated parameter information) from the reservation system 16 using either a “push” and/or “pull” arrangement that will be appreciated by one skilled in the art. For example, in some embodiments, the host computer 12 may periodically (such as, for example, every 15 minutes) poll a ticketing module of the reservation system 16 to receive a second product (and related parameter, such as purchase price and/or volume of ticket sales) that may have been purchased via the reservation system 16. In other embodiments, the reservation system 16 (and/or a ticketing module and/or accounting system associated therewith) may periodically “push” purchase data to the host computer 12 such that the host computer may receive the second travel product (and parameters (such as purchase price and/or sales volume)) associated therewith).

Once the host computer 12 receives a second travel product (and its associated parameters) and ascertains the category of the second product, the host computer 12 may then utilize the database 17 information to generate an average parameter value that may be directly comparable to the received second travel product value such that a meaningful comparison may be made. For example, the host computer 12 may utilize data within the database 17 to determine an average of the first parameters (price listings, for example) associated with each of the plurality of first travel products (airline tickets, for example) in the category (Saturday night, first-class, non-stop flights from New York to San Francisco, for example). In some embodiments, the database 17 may comprise a commercially-available relational database program such that data within the database may be arranged and more easily manipulated by the host computer 12 in order to determine the average parameter for a specific given category of travel product (such as, for example, a price listing for airline tickets on Saturday night, first-class, non-stop flights from New York to San Francisco).

In some embodiments, wherein the system of the present invention is used to identify potentially erroneous airline fares, the host computer 12 may generate an average of the first parameters (such as an average price) in a hierarchy of different categories such that even if an exact match of the category of the second travel product (i.e., a purchased airline fare) is not available, the comparison (see description below) between the second parameter (associated with the second travel product) and the average may still be accomplished (albeit with an average of parameters corresponding to products that are part of a closely related, but not matching, category). For example, in some embodiments, the host computer 12 may determine historical airline fare averages based on the following hierarchy of categories: Level 1, flight origin and destination, travel product provider (airline, for example), travel product class, during the last 60 days; Level 2, flight origin and destination, travel product provider (airline, for example), during the last 90 days; Level 3, flight origin and destination, over the last 12 months; and Level 4, travel product provider (airline, for example), over the last 12 months. According to such a hierarchy system, if no historical average exists (or may not be computed) for the Level 1 category, the host computer 12 may next use the Level 2 category to compute and/or retrieve an average parameter for comparison with the second parameter (associated with the received second travel product).

The host computer 12 may then compare the second parameter (such as price and/or number of tickets sold) for the second travel product received from the reservation system 16 and subsequently detect situations in which the second parameter differs from the computed average parameter. A difference between the second parameter and the computed average parameter may be indicative, for example, of an incorrect fare price. For example, if the determined average fare price for the first-class, Saturday night non-stop flight from New York to San Francisco is $600, a received second parameter (price) indicating a price of $50 for a comparable travel product may indicate that a pricing error is present. In more competitive fare markets, even a minor deviation from the average may be indicative of a pricing error. Thus, in some embodiments of the system of the present invention, the host computer 12 may manipulate data within the database 17 to provide detailed, multi-variable categories for the plurality of first travel products so as to be capable of determining a more comparable and/or useful parameter average.

According to some embodiments, parameters other than travel product price may be used to detect potential pricing errors. For example, historical data for a number of ticket purchases for a given category may be compared to received sales data related to a particular fare by the host computer 12 to determine situations in which the sales volume of the travel product differs substantially from the historical average.

Furthermore, in some embodiments of the system of the present invention, the host computer 12 of the present invention may also verify the determined relation between the parameter associated with the second travel product and the average to ensure that the determined difference (which may exceed, in some embodiment, a specified margin of difference, as described above) is indicative of an potential incorrectly-priced travel product. According to some system embodiments, the host computer 12 may verify the determined relation between the parameter associated with the second travel product and the average by searching for the parameter (such as an airline fare price) associated with the second travel product in one or more alternate sources that may be in communication with the host computer via the network 14. For example, the host computer 12 may be capable, in some embodiments, of automatically verifying the determined relation between the parameter and the average by searching for a confirmatory and/or commensurate parameter (such as a similar airline fare price) associated with the second travel product on one or more of: a product provider website (operated by an airline reservation system 17, for example), a secondary reservation system in communication with the host computer via the network 14 (such as, for example, a travel booking website), a centralized CRS (such as SABRE, for example), and/or other network-accessible sources. According to some embodiments, the host computer 12 may also perform a “self check” to verify the accuracy of the average parameter calculation.

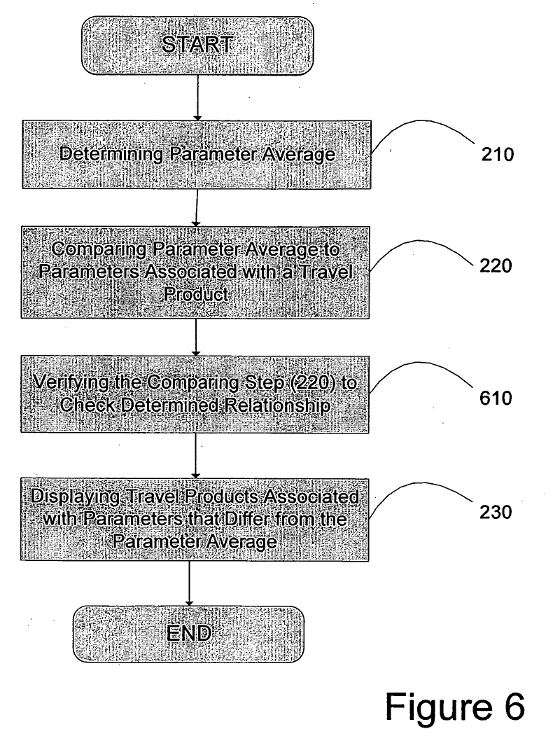

In some embodiments, the host computer 12 of the present invention may comprise a desktop computer that is capable of being controlled by an operator of the system such that the operator (via the keyboard interface 26) may interrogate other computer sources to verify the determined relation between the parameter and the average. For example, an operator of the present system may manually interrogate (using the host computer 12) one or more travel websites (including, for example, travel web logs (“blogs”), online travel forums and message boards, and/or online shopping websites) to search for comparable travel products (such as a similar flight itinerary) associated with a given parameter (such as fare price). Thus, in some system embodiments (see, for example, the flow chart of FIG. 6), the host computing element 12 may display one or more travel products having potentially erroneous pricing values (as indicated by parameter values that differ from the determined average) only after having verified and/or disproved such potential pricing errors using the host computer 12 in communication with the network 14.

As shown generally in the exemplary display 300 of FIG. 3, the host computer 12 may also be capable of displaying the second travel product when the parameter 315 (such as purchase price of the fare, for example) associated with the travel product is different from the determined average 316. In other embodiments, the host computer may display the second travel product only when the parameter associated with the travel product is different from the determined average by a selected margin (see element 317 of FIG. 3, for example). Furthermore, in some embodiments, an operator of the system of the present invention may specify a margin 317 (such as, for example, 15 percent) between the determined average 316 and the parameter 315 associated with the received travel product that must be detected by the host computer 12 in the comparison step (see FIG. 2, step 220, for example) before the travel product is displayed (see element 300, FIG. 3) as a potential pricing error. In the example listed above, the average parameter determined by the host computer 12 is $600 for the first-class flight of interest. Because this average parameter differs from the second ($50) parameter (associated with the second travel product (the $50 first-class New York to San Francisco fare price)) received from a reservation system 16 by more than the 15 percent margin, the host computer 12 displays the questionably-priced second travel product to the operator of the system for further scrutiny, verification, and/or automated reporting (as described in further detail below). An operator of the system of the present invention may also, in some embodiments, further specify a hierarchy of selected margins (see element 317 of FIG. 3, for example) between the second parameter and the average parameter such that the potential severity of a potential pricing error may be categorized. For example, an airline fare having a second parameter (price) discounted between 20 and 35 percent of the next lowest competitor may trigger a “Level 1” notification, wherein the host computer 12 may automatically notify a product provider and/or an operator (via the display 300, and/or via the network 14) only during business hours. A “Level 3” notification, however, may be triggered by a detected margin that exceeds 50%, wherein the host computer 12 may notify a product provider and/or an operator (via the display 300, and/or via the network 14) at any time.

FIG. 3, shows an exemplary display of potential incorrectly priced second travel products (airline fares, for example), as detected by one embodiment of the system of the present invention on a particular date. The display 300 includes a summary listing 310 of “outliers” that are listed along with parameters that may include, but are not limited to: airline code 311 (product provider), origin of flight 312, destination of flight 313, number of tickets purchased under this fare pricing 314, the second parameter 315 (the price paid for the fare), the average parameter 316 (the historical average for a comparable fare category), and the margin of difference (percent difference) between the average parameter and the received second parameter 317. The display 300 shown in FIG. 3 also includes a more detailed listing 320 showing a second travel product purchase record that may include, but is not limited to: date and time of the purchase 322 of the second travel product, a unique code (such as a PNR code) 323 for the product purchase, the airline 321 (or other product provider) of the purchased second travel product, the number of passenger tickets purchased 324, and the parameter (purchase price) 315 corresponding to the second travel product. According to some embodiments, the display 300 may be monitored manually by an operator of the system of the present invention. Furthermore, in some embodiments, the display 300 of potentially incorrectly-priced products (or “outliers”) may also be transmitted to a third-party contractor that may be tasked with monitoring the system for potential pricing issues.

Furthermore, because the operator of the system of the present invention may be in a business relationship with one or more travel product providers (such as, for example, airlines, hoteliers, etc), it may be advantageous for the host computer 12 of the present invention to be capable of directly and/or automatically notifying the travel product providers of potential erroneously-priced travel products such that the travel product providers may remove travel products from the inventory system 17 and/or correct the listed parameters (such as price) associated with the travel products before significant profit losses are realized due to the rapid sale of incorrectly-priced travel products (such as, for example $50 round-trip first class fares for a transcontinental flight). Thus, in some system embodiments of the present invention, the host computer 12 may transmit the displayed travel products (see element 300, FIG. 3) to a travel product provider (such as the operator of one or more reservation systems 17) via the network 14. For example, in some embodiments, the host computer 12 may comprise (as shown generally in FIG. 1B), a network interface 28 in communication with the network 14 such that the host computer may be capable of directly transmitting the displayed travel products 310 (comprising, for example, “outliers”) to the travel product provider via at least one of the following methods: sending an e-mail message to the travel product provider via the computer network 14; displaying (see generally, the display 300 of FIG. 3) the travel product via a travel product provider user interface (such as a personal computer housing a product provider reservation system 17); and/or publishing the displayed travel product via the computer network 14 (by, for example, publishing the displayed travel product on a controlled-access internet portal that may be accessed by selected product providers and/or operators of selected reservation systems 17). Thus, the host computer 12 of the system of the present invention may quickly inform selected parties (such as reservation system 17 operators, and/or other travel product providers) of potential incorrectly-priced travel products that are displayed 300 by the system of the present invention.

In addition, some embodiments of the system of the present invention may also trigger a number of automated processes for removing detected potentially incorrect product pricing from a reservation system 16 and/or other electronic point of sale. For example, the display of second travel products having disparate parameters (such as, for example, exceptionally low prices and/or exceptionally high sales volumes) may trigger the automated removal and/or “locking” of such products in a reservation system 16 such that the displayed second products may not be sold.

As illustrated in exploded FIG. 1B, the host computer 12 system of the present invention is generally embodied as a typical computer, server or mainframe system depending on the embodiment. They system generally includes a processing element 20, such as a microprocessor, VLSI, ASIC, etc., a storage device 22, display 24, keyboard and mouse interface 26, and a network interface 28. Some system embodiments of the present invention provide a keyboard interface 26 and display 24 in communication with the host computer 12 such that an operator of the present system may input precise selected margins (between the parameter and the determined parameter average) that trigger the display function (indicating a potential pricing error). Furthermore, some embodiments of the system of the present invention also comprise a memory device 22 for storing comparison schemes which may indicate selected margins for a variety of different travel product categories (that may be defined by the geographical travel market, itinerary, travel product provider, and/or other variables). The memory device 22 may also be utilized to store parameter averages for a number of different travel product categories so as to expedite the comparison step (see step 220, of FIG. 2, for example) performed by the host computer 12.

The various operations of the present invention may be performed either by hardware in the form of ASIC chips or other specialized hardware or by operation of software ran by a processing element. In the latter case, the storage device 22 may also further include the various computer software programs and modules used to implement the operations of the present invention.

FIG. 2 is a generalized illustration of the operations performed by the systems, methods, and computer program products of the present invention to generate the display 300 illustrated in FIG. 3. The description of this operation is given by example to the display 300 listing of potentially mispriced second travel products shown in FIG. 3 and to the system schematic shown generally in FIGS. 1A and 1B.

FIG. 2 shows a method for detecting and displaying pricing errors corresponding to one or more travel products selected from an inventory system, wherein the inventory system comprises travel products (such as, for example, airline fares) and parameters (such as fare prices and or fare sales volume) associated with the travel products. The method embodiment shown generally in FIG. 2 first comprises step 210 for determining an average of a parameter associated with each of a plurality of first travel products in at least one category. As discussed above with respect to the system embodiments of the present invention, the determining step 210 generally comprises determining an average parameter, which may include, for example, an airline fare price and an airline fare sales volume for a particular category of travel products (such as airline fares with a given fare code for travel on a given airline between a particular pair of airports). As described above, the determining step 210 may also comprise interrogating a database 17 in order to access stored data including a plurality of first travel products (in at least one category) having a corresponding plurality of parameters. The categories and corresponding parameters of the plurality of first travel products stored in the database 17 may comprise, for example, fare prices for a specific air travel itinerary, fare prices on a particular airline, fare prices to and/or from a specific geographical region, fare prices for a particular airline fare code, and other category/parameter combinations that may be used to generate the average of the parameter associated with each of the plurality of first travel products. Furthermore, in some method embodiments of the present invention, the determining step 210 may also comprise accessing a memory device 22 (see FIG. 1B, for example) having a travel product cache 30 containing parameter data (such as, for example historical pricing data and/or historical sales volume data) associated with each of the plurality of first travel products within the at least one travel product category.

According to some embodiments, the average determining step 210 of the method embodiments of the present invention may be performed after receiving one or more second travel products from a reservation system 16 such that the category defined by the second travel product (i.e., a purchased airline fare) may be used to define the category of the first travel products (and first parameters associated therewith) to determine the average in step 210. For example, the host computer 12 of the present invention may receive notification of the purchase of one or more second travel products, having a particular parameter (i.e., a $50 purchase price) within a particular category (i.e., a block of purchased fares for a Saturday night, non-stop, first-class flight from New York to San Francisco). In response, the determining step 210 may comprise determining an average of a comparable parameter (purchase price) for first travel products (airline fares) within the same category (i.e., Saturday night, non-stop, first-class flights from New York to San Francisco) in order to perform a more valid comparison (see step 220 below). According to some method embodiments, step 210 may also comprise determining an average of other parameter types that may be associated with each of a plurality of first travel products in at least one category. For example, step 210 may also comprise determining an average sales volume for a particular travel product (airline fare, for example) in a particular category to compare (see step 220, described below) to a second travel product received from a reservation system 16 by the host computer 12.

FIG. 2 also shows step 220 for comparing a second travel product, in the at least one category and associated with the parameter (such as fare price), to the plurality of first travel products so as to determine a relation between the parameter associated with the second travel product and the average. Step 220 may, in some embodiments, comprise directly comparing the parameter average (as computed in step 210, for example) to a comparable parameter associated with the second travel product (i.e., an air fare within the same category and the plurality of first travel products). The results of the comparing step 220 may be displayed (see step 230, below) in the display of second travel products having potential pricing errors as shown generally in FIG. 3, element 300. For example, the percentage difference 317 between the determined parameter average 316 and the parameter associated with the second travel product 315 may be displayed to a user such that the user may further verify (see step 610, FIG. 6, below) the comparing step 220. According to some embodiments, the comparing step 220 may be performed by the host computer 12 of the present invention substantially simultaneously with the determining step 210 disclosed above. For example, the host computer 12 may access one or more databases 17 comprising parameter data associated with a plurality of first travel products in order to determine a parameter average defined by a category that is directly comparable to a second travel product received from a reservation system 16. In performing the comparing step 220, the host computer 12 may also access (via the network 14, for example) the purchasing modules and/or other components of a reservation system 16 so as to be capable of receiving purchasing information (or other parameter information) associated with one or more second travel products. Thus, the host computer may substantially simultaneously perform the determining 210 and comparing 220 steps described above in order to provide near-real time monitoring of one or more reservation systems for potential pricing errors that may be revealed by substantial differences between the determined average parameter (i.e., an average historical fare price) and a parameter associated with a second travel product (i.e., a purchased airline fare) received from one or more reservation systems 16.

As shown in FIG. 2, some method embodiments of the present invention further comprise step 230 for displaying the second travel product when the parameter associated with the second travel product is different from the parameter average determined in step 210. According to some method embodiments, shown generally in FIG. 3, step 230 may comprise providing a detailed display 300 of potential pricing errors detected in a reservation system. For example, the host computer 12 may display (via an integrated display 24, or other user interface in communication therewith) a listing of second travel products having parameters (fare price 315, for example) that differ from the determined parameter average 316 (average fare price in a comparable category). As shown in FIG. 3, step 230 may comprise listing the second travel products by along with their particular category and/or parameter attributes. For example, the display 300 may comprise a summary listing 310 which may include, in some embodiments: a travel product provider code 311 (airline identifier, for example), an origin 312 (departure city and/or departure airport code), a destination 313 (destination city and/or destination airport code), a second travel product sales volume 314 (listing of the number of air fares sold in the time frame of interest), a received parameter associated with the second travel product 315 (i.e., the fare price at which the air fare was sold), and the determined parameter average 316 (i.e., the historical average fare price for a comparable itinerary). The displaying step 230 may also comprise displaying a detailed listing 320 (in addition to or in lieu of the summary listing 310) showing a second travel product purchase record that may include, but is not limited to: date and time of the purchase 322 of the second travel product, a unique code (such as a PNR code) 323 for the product purchase, the airline 321 (or other product provider) of the purchased second travel product, the number of passenger tickets purchased 324, and the parameter (purchase price) 315 corresponding to the second travel product.

According to some method embodiments, the displaying step 230 further comprises displaying the second travel product only when the parameter associated with the travel product is different from the average by a selected margin (see element 317). In some such method embodiments, the display 300 (generated by a host computer 12, for example) may further include a listing (by second travel product) of the computed margin of difference 317 between the parameter 315 and the determined average parameter 316 for a comparable travel product (such as a similar itinerary, fare code, class, time of travel, airline, etc.).

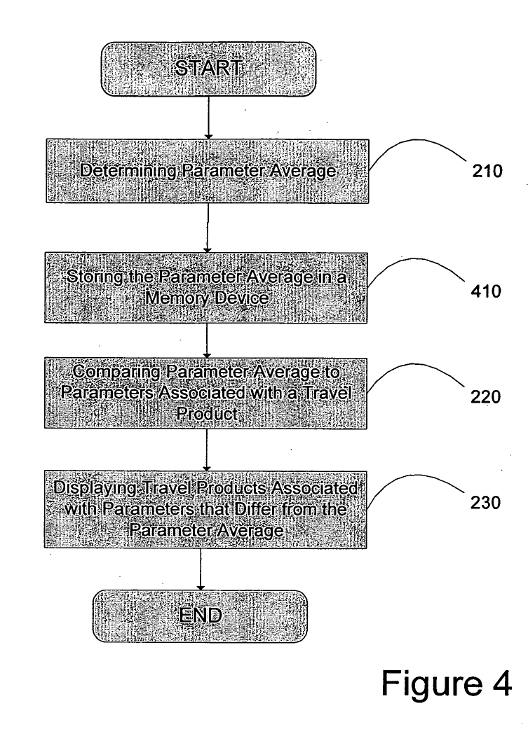

FIG. 4 shows an alternate method embodiment further comprising step 410 for storing the average of the parameter in a memory device in communication with an inventory system (such as a reservation system 16). As shown generally in FIGS. 1A the one or more databases 17 may be in communication with the reservation systems 16 and/or host computer 12 of the present invention. According to some method embodiments, step 410 for storing the average of the parameter may be performed by a memory device that stores one or more of the databases 17. Thus, in some such method embodiments, the database 17 may store parameter averages for a plurality of travel product categories such that the comparing step 220 may be easily performed by a host computer 12 in communication with both the reservation system 16 and the database 17 tasked with the parameter average storing step 410. According to some alternate method embodiments, the storing step 410 may also be accomplished by a memory device 22 (comprising, for example, a travel product cache populated with historical travel product parameters and/or categories taken from reservation systems 16 and/or databases 17). As shown in FIG. 1B, the memory device 22 may be integrated with and/or in communication with the host computer 12 such that the host computer may quickly compare (as in step 220, described above) one or more stored parameter averages with a parameter associated with a second travel product received from one or more reservation systems 16.

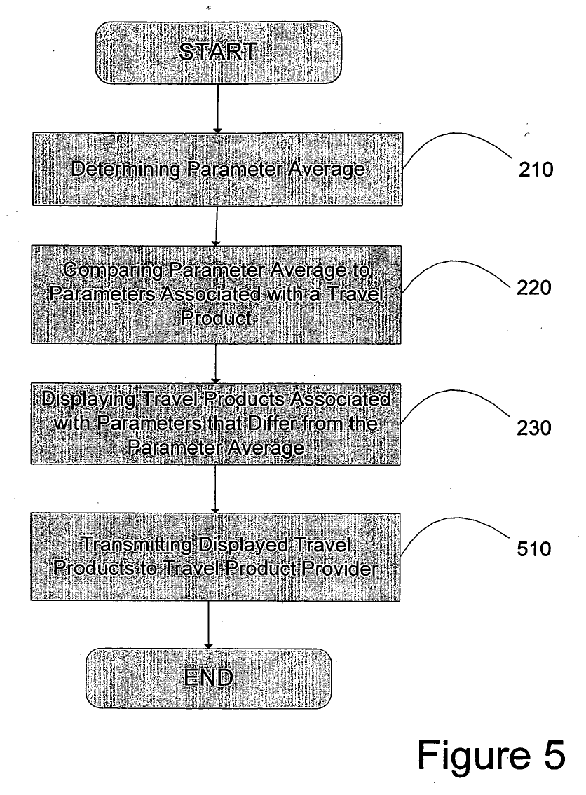

As shown generally in FIG. 5, some method embodiments of the present invention may also comprise step 510 for transmitting the displayed travel products (presented in a display 300, for example, as described above with respect to method step 230) to a travel product provider (such as an airline, hotelier, rental car company, and/or other travel product provider). For example, as shown generally in FIG. 1A, a travel product provider (such as an airline) may provide a reservation system 16 (and/or be in communication with a network 14 via such a reservation system 16) such that a host computer 12 of the present invention may perform step 510 by transmitting the displayed travel products (i.e., a summary listing of potentially mispriced airline fares as shown in element 310 of FIG. 3) to one or more reservation systems 16 via the network 14. Furthermore, the transmitting step 510 may also be accomplished by an operator of the present system that may manually and/or semi-automatically transmit the displayed travel products (indicating potential pricing errors) to a travel product provider using, for example, a keyboard interface 26 and display 24 included as part of the host computer 12. According to other method embodiments of the present invention, the transmitting step may also be performed by and/or with the aid of the host computer via a variety of communication pathways, which may include, but are not limited to: sending an email (generated by an operator of the present system and/or generated automatically by the host computer 12) to the travel product provider (such as an airline); displaying the travel product (i.e., in a display 300) via a travel product provider user interface (which may be in communication with the host computer 12 via the network 14); publishing the displayed travel product (i.e., in a display 300) via a network portal (which may be selectively accessed by one or more travel product providers via the network 14); and combinations of such methods.

FIG. 6 shows another method embodiment of the present invention further comprising step 610 for verifying the determined relation (determined in the comparing step 220 discussed above) between the parameter associated with the second travel product and the parameter average (determined in step 210, discussed above). According to some method embodiments, the verifying step 610 may be performed by a host computer 12 in order to verify the determined relation between the parameter associated with the second travel product and the average to ensure that the determined difference (which may exceed, in some embodiment, a specified margin of difference, as described above) is indicative of an potential incorrectly-priced travel product. According to some method embodiments, the verification step 610 may comprise verifying the determined relation between the parameter associated with the second travel product and the average by searching for the parameter (such as an airline fare price and/or airline fare sales volume) associated with the second travel product in one or more alternate sources that may be in communication with the host computer 12 via the network 14. For example, the host computer 12 may, in some method embodiments, automatically verify the determined relation between the parameter and the determined average (from step 210) by searching for a confirming parameter (such as a similar airline fare price) associated with the second travel product on one or more of: a product provider websites (operated by an airline reservation system 17, for example), a secondary reservation system in communication with the host computer via the network 14 (such as, for example, a travel booking website), a centralized CRS (such as SABRE, for example), and/or other network-accessible sources.

According to other method embodiments, the verification step 610 may be manually accomplished by an operator of the present system using, for example, the host computer 12, which may comprise a desktop computer that is capable of being controlled by an operator of the system such that the operator (via the keyboard interface 26) may interrogate other computer sources to perform the verification step 610. For example, an operator of the present system may perform the verifying step 610 by reviewing (using the host computer 12) one or more travel websites (including, for example, travel web logs (“blogs”), online travel forums and message boards, and/or online shopping websites) to search for comparable travel products (such as a similar flight itinerary) associated with a given parameter (such as fare price). Thus, as shown in FIG. 6, the displaying step 230 may in some embodiment, show travel products having potentially erroneous pricing values only after performing a verification step 610.

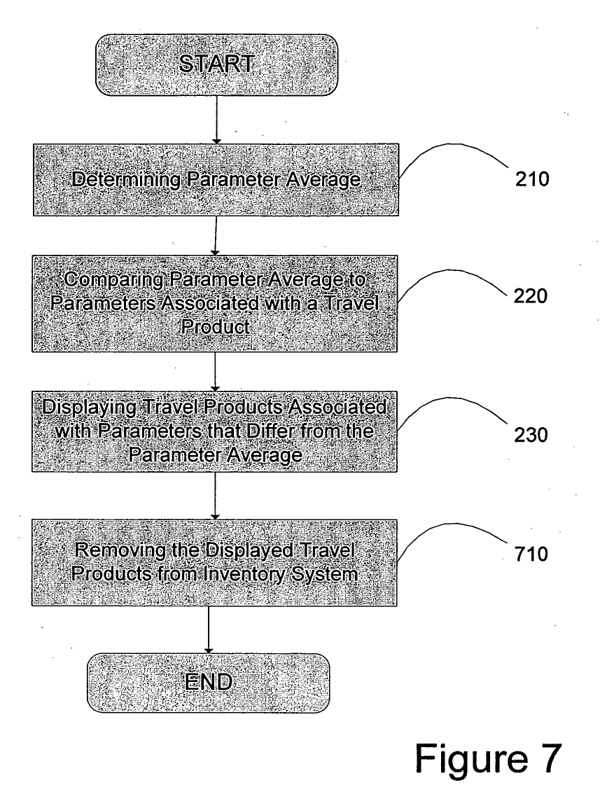

According to some method embodiments of the present invention, the determining step 210, comparing step 220, and displaying step 330 may accurately predict the presence of pricing errors in one or more reservation systems 16. In addition, as discussed above with respect to FIG. 6, such determinations may be independently verified using the verifying step 610 (which may be performed automatically in some instances by a host computer 12). In some embodiments, shown generally in FIG. 7, the determination of potential pricing errors may also trigger a removing step 710 for removing the displayed second travel product (shown in the summary display 310 of FIG. 3, for example) from the inventory system 16 so as to stem the sale of potential incorrectly-priced travel products. The removing step 710 may also be performed substantially automatically by a host computer 12 with access to the display 300 generated, for example, by method step 330 discussed above. According to some method embodiments, the removing step 710 may also comprise “locking” and/or masking second travel products that have been displayed as potential “outliers” when compared (see step 220) with a plurality of first travel products.

As mentioned above, although the specific embodiments are directed to use of the present invention with detecting pricing errors associated with the sale of airfares, the present invention is not so limited. The present invention can be used to assess pricing and/or sales volume parameters associated with rail and bus fares, hotel rates, cruise fares, car rental pricing, events pricing and ticketing (including sports and leisure activities), etc. For example, if the systems described above are used for hotels, the system could determine historical pricing averages for a particular hotel room grade (i.e., suite) in a particular city, and for a particular season. It may also compare such averages to detected current and/or proposed pricing for a comparable hotel booking to detect potential pricing errors prior to listing such a hotel booking rate via a reservation system. For car rentals, the system could be used to generate an average number of luxury cars rented from a particular airport rental facility on a summer weekday. The system may then use the generated average to provide a computer threshold. Thus, a host computer 12 may then display to an operator a rental booking detail (including price and other category details) if the number of bookings in the category suddenly spike above the generated average. Thus, the system may detect rental car pricing errors revealed by an unusual rise in the number of bookings for a particular rental car category before a large number of rental bookings are allowed under a potentially erroneous pricing scheme. Similar pricing errors may also be detected in the train, cruise, and events embodiments by detecting parameter values that exceed and/or differ somewhat from specific and comparable averages.

In addition to providing apparatus and methods, the present invention also provides computer program products for performing the operations described above. The computer program products have a computer readable storage medium having computer readable program code means embodied in the medium. With reference to FIG. 1B, the computer readable storage medium may be part of the storage device 22, not shown, and may implement the computer readable program code means to perform the above discussed operations.

In this regard, FIGS. 2 and 3-7 are block diagram illustrations of methods, systems and program products according to the invention. It will be understood that each block or step of the block diagram and combinations of blocks in the block diagram can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for detecting and displaying pricing errors corresponding to one or more travel products selected from an inventory system, the system comprising:
a database comprising a plurality of first travel products in at least one category having a corresponding plurality of first parameters,
a host computing element in communication with the inventory system and said database;
wherein said host computing element receives, from the inventory system, a second travel product in the at least one category having a corresponding second parameter;
wherein said host computing element determines an average of the first parameters associated with each of a plurality of first travel products in the at least one category;
wherein said host computing element compares the second parameter and the average; and
wherein said host computing element displays the second travel product when the second parameter associated therewith is different from the average so as to identify potential pricing errors corresponding to the displayed second travel product.

2. A system according to claim 1, wherein the parameter is at least one of:
price;
sales volume; and
combinations thereof.

3. A system according to claim 1, wherein the at least one category is at least one of:
a travel product geographical market area;
a travel product supplier;
a travel product itinerary;
an airline fare having a selected fare code;
an airline fare for travel on a selected itinerary; and
combinations thereof.

4. A system according to claim 1, wherein said host computing element further comprises a memory device for storing the average.

5. A system according to claim 1, further comprising a user interface in communication with said host computing element, and wherein said host computing element further displays the second travel product via the user interface when the second parameter associated therewith is different from the average.

6. A system according to claim 1, wherein said host computing element further displays the second travel product when the second parameter associated therewith is different from the average by a selected margin.

7. A system according to claim 1, wherein said host computing element further transmits the displayed second travel product to a travel product provider in communication with the host computing element.

8. A system according to claim 7, wherein said host computing element further comprises a network interface in communication with a computer network and wherein said host computing element further transmits the displayed second travel product to the travel product provider by at least one of:
sending an email to the travel product provider via the computer network;
displaying the second travel product via a travel product provider user interface;
publishing the displayed second travel product via the computer network; and
combinations thereof.

9. A system according to claim 1, wherein said host computing element further verifies the comparison of the second parameter and the average.

10. A system according to claim 9, wherein said host computing element further comprises a computer network interface in communication with a computer network and wherein said host computing element further verifies the comparison of the second parameter and the average by at least one of:
searching for the second parameter associated with the second travel product on a travel product provider website via the computer network;
searching for a comparable parameter associated with a comparable second travel product within the at least one category via the computer network;
searching for the second parameter associated with the second travel product on the inventory system; and
combinations thereof.

11. A system according to claim 1, wherein said host computing element further removes the displayed second travel product from the inventory system.

12. A method for detecting and displaying pricing errors corresponding to one or more travel products selected from an inventory system, the inventory system comprising travel products and parameters associated with the travel products, the method comprising:
determining an average of a parameter associated with each of a plurality of first travel products in at least one category;
comparing a second travel product in the at least one category, the second travel product being associated with the parameter, to the plurality of first travel products so as to determine a relation between the parameter associated with the second travel product and the average;
displaying the second travel product when the parameter associated with the second travel product is different from the average so as to identify possible pricing errors corresponding to the displayed second travel product.

13. A method according to claim 12, wherein the parameter is at least one of:
price;
sales volume; and
combinations thereof.

14. A method according to claim 12, wherein the at least one category is at least one of:
a travel product geographical market area;
a travel product supplier;
a travel product itinerary;
an airline fare having a selected fare code;
an airline fare for travel on a selected itinerary; and
combinations thereof.

15. A method according to claim 12, further comprising storing the average of the parameter in a memory device in communication with the inventory system.

16. A method according to claim 12, wherein said displaying step further comprises displaying the second travel product when the parameter associated with the travel product is different from the average by a selected margin.

17. A method according to claim 12, further comprising transmitting the displayed travel product to a travel product provider.

18. A method according to claim 17, wherein said transmitting step comprises transmitting the displayed travel product to the travel product provider by at least one of:
sending an email to the travel product provider;
displaying the travel product via a travel product provider user interface;
publishing the displayed travel product via a network portal; and
combinations thereof.

19. A method according to claim 12, further comprising verifying the determined relation between the parameter associated with the second travel product and the average.

20. A method according to claim 19, wherein said verifying step further comprises verifying by at least one of:
searching for the parameter associated with the second travel product on a travel product provider website;
searching for a comparable parameter associated with a comparable second travel product within the at least one category via a computer network;
searching for the parameter associated with the second travel product on the inventory system; and
combinations thereof.

21. A method according to claim 12, further comprising removing the displayed second travel product from the inventory system.

22. A computer program product for detecting and displaying pricing errors corresponding to one or more travel products selected from an inventory system, the inventory system comprising travel products and parameters associated with the travel products, the computer program product comprising a computer-readable storage medium having computer-readable program code instructions stored therein comprising:
first computer instruction means for determining an average of a parameter associated with each of a plurality of first travel products in at least one category;
second computer instruction means for comparing a second travel product in the at least one category, the second travel product being associated with the parameter, to the plurality of first travel products so as to determine a relation between the parameter associated with the second travel product and the average; and
third computer instruction means for displaying the second travel product when the parameter associated with the second travel product is different from the average so as to identify possible pricing errors corresponding to the displayed second travel product.

23. A computer program product according to claim 22, wherein the parameter is at least one of:
price;
sales volume; and
combinations thereof.

24. A computer program product according to claim 22, wherein the at least one category is at least one of:
a travel product geographical market area;
a travel product supplier;
a travel product itinerary;
an airline fare having a selected fare code;
an airline fare for travel on a selected itinerary; and
combinations thereof.

25. A computer program product according to claim 22, further comprising fourth computer instruction means for storing the average of the parameter in a memory device in communication with the inventory system.

26. A computer program product according to claim 22, wherein said third computer instruction means for displaying further comprises fifth computer instruction means for displaying the second travel product when the parameter associated with the travel product is different from the average by a selected margin.

27. A computer program product according to claim 22, further comprising sixth computer instruction means for transmitting the displayed travel product to a travel product provider.

28. A computer program product according to claim 27, wherein said sixth computer instruction means further comprises seventh computer instruction means for transmitting the displayed travel product to the travel product provider by at least one of:
sending an email to the travel product provider;
displaying the travel product via a travel product provider user interface;
publishing the displayed travel product via a network portal; and
combinations thereof.

29. A computer program product according to claim 22, further comprising eighth computer instruction means for verifying the determined relation between the parameter associated with the second travel product and the average.

30. A computer program product according to claim 29, wherein said eighth computer instruction means for verifying further comprises ninth computer instruction means for verifying by at least one of:
searching for the parameter associated with the second travel product on a travel product provider website;
searching for a comparable parameter associated with a comparable second travel product within the at least one category via a computer network;
searching for the parameter associated with the second travel product on the inventory system; and
combinations thereof.

31. A computer program product according to claim 22, further comprising tenth computer instruction means for removing the displayed second travel product from the inventory system.
